(19) United States
(12) Patent Application Publication
(10) Pub. No.: US 2008/0270450 A1
(43) Pub. Date: Oct. 30, 2008

(54) Using interface events to group files

(76) Inventors: Alistair Veitch, Mountain View, CA (US); Karl Anders Gyllstrom, Chapel Hill, NC (US); Henri J. Suermondt, Sunnyvale, CA (US); Pankaj Mehra, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/796,904

(22) Filed: Apr. 30, 2007

(51) Int. Cl. G06F 17/30

(52) U.S. Cl. 707/102; 707/100; 707/5; 707/E17.01; 707/E17.017; 707/E17.065

(57) ABSTRACT

Various embodiments are directed to using interface events to group files. One embodiment, collects user interface events, uses the user interface events to generate a group of files that are related to a task, and enhances a query to discover files associated with the task.

### BACKGROUND

The amount of information stored on personal computer systems is enormous and rapidly expanding. Some file systems use hierarchical organization to store computer files. Files are named and placed in a directory. The number of files, however, can easily exceed thousands or tens of thousands. Searching and locating specific files can be quite challenging.

Content-based search tools are used to locate files on a computer system. A user enters a keyword or words, and the tool searches given files for the occurrence of the keyword. The tool then displays the search results to the user.

Content-based searches provide a simple search tool, but are not effective for many types of searches. For example, a user might forget an important keyword or search for a file that does not contain the keyword entered in the search query. In other instances, some files, such as images, are not searchable with keywords since these files do not contain text.

In view of the large amount of files and data stored on computer systems, users need effective tools for organizing and searching such files.

### BRIEF DESCRIPTION OF THE DRAWINGS

FIG. 1 illustrates a high-level block diagram of a computer system according to an exemplary embodiment.

FIG. 2 illustrates a flow diagram for building a relation graph and conducting a search according to an exemplary embodiment.

FIG. 3A illustrates relationships between plural windows according to an exemplary embodiment.

FIG. 3B illustrates the windows of FIG. 3A with weaker lines removed to reveal clusters according to an exemplary embodiment.

FIG. 4 illustrates a block diagram of a computer according to an exemplary embodiment.

### DETAILED DESCRIPTION

Embodiments are directed toward systems, methods, and apparatus for utilizing user interface (UI) events to develop file context information. One embodiment uses UI information to discover groups of related files stored in a computer. UI events are recorded and stored, along with file access information such as read, write, open, etc. By way of example, UI events include, but are not limited to, keyboard inputs, window focus changes on an application in a display, clicks from a mouse or pointer, window visibility events, widget focus changes, and mouse or pointer movement. Logs are then processed in various ways in order to group files based on the notion of user tasks. For example, files used in a related or same logical task are grouped together. By contrast, non-related files are separated.

Once the files are grouped, the groupings are used in a variety of ways. For instance, the groups assist in desktop searching. By way of example, if a keyword search for files locally stored on a personal computer discovers document A, context information previously associated with document A is used to find that files B and C (example, a jpeg image and spreadsheet file) were used as part of the same task. Files A, B, and C are discovered as being related and relevant to the input query even though these files were created with different applications (example, file A created with a word processor application, file B created with a photo editing application, and file C created with a spreadsheet application). Further, even if files B and C did not match the keyword search that produced file A, files B and C would still be discovered since they are related and relevant to the search.

For discussion purposes, exemplary embodiments are discussed in connection with enhancing desktop or personal computer system searches. Exemplary embodiments, however, include a variety of uses. By way of example, embodiments are used with various tasks that have common or related files grouped together, such as information life cycle management tasks (example, archive all of the documents associated with a task in similar or same storage locations), provenance tasks (example, given a file A, determine other files used with, related to, or derived from file A), and discovery tasks (example, locate all documents accessed or opened during a specified time period).

One embodiment extracts conceptual relationships between files by their temporal access patterns at the file system layer. Because of inherent limitations in reconstructing a user's document interaction from a stream of low-level file operations, one embodiment augments the file event stream with a stream of window focus events from the UI layer. Algorithms analyze this stream, determine relevancy, and present search results to a user.

Exemplary embodiments use a temporal context for desktop searches wherein files that are accessed in the same time period are likely to share a task commonality—even when those files share little or no content similarities. One embodiment comprises two main parts: context building and searching. Contextual relationships are captured by a relation graph, where nodes represent files, and the links between them reflect the strength of their contextual relationship. To build the relation graph, a file system monitor records file operations, such as open, write, and read, as a user interacts with a computer system. While these events occur, one embodiment maintains a relation window (RW) that includes a log of all file events occurring in the last n-seconds. When a new write event enters the RW, each file that experiences a read event in the current RW has its link to the newly written file incremented on the relation graph. On the search side, upon a user query, a pool of results is created using a text based method (tf-idf: term frequency—inverse document frequency). This pool is then augmented with contextually related files for each file in the original pool. One embodiment uses window focus events or active window events that are generated whenever a user changes the active window (example, through a mouse click, alt-tab hot key, or minimization of the active window).

Exemplary embodiments track various UI events. By way of example, such events include, but are not limited to, clicks (example with a mouse or pointer), keyboard inputs, window focus changes, determinations of which windows are visible versus obscure on a display, determinations of which windows are minimized to an icon, determinations of which windows are enlarged from an icon, etc.

One issue with a file system based approach is the difficulty in differentiating background noise (example, reads from a virus checker) from user events (example, writes from a text editor). For example, while editing a text document, a user periodically saves the document, which generates a stream of file write operations to the file system. If a virus checker begins to run in the background, then it can generate a large volume of read operations as it scans the user's directory structure for anomalies. Although the events generated by the virus checker are not part of the user's current task, such events interleave with the stream of events generated by the user's action and thus appear to be related when the file layer stream is examined.

While much of the background noise is generated by non-user owned operating system (OS) processes, such noise can also be generated by passive user processes (example, a text editor that automatically saves open files even when the editor is not being actively used). For example, if a user is drafting a text document with a word processor, the application generates periodic file save events. Even if the user minimizes the window and switches to a new task, the application can generate auto-save events that appear as though the document were related to a current task.

Exemplary embodiments also address situations when applications generate too little information (i.e., insufficient file events generated to provide enough information about the way in which files are being used). For example, some PDF applications read a PDF file completely to memory upon opening. The application thereafter does not generate operations on the file as the user works with it.

The Focused Window Filtering (FWF) algorithm, the Focused Task Filtering (FTF) algorithm, and other exemplary embodiments resolve the issues of background noise (i.e., when too much information is generated) and issues of lack of file events to generate information.

In FWF, the hypothesis is that the currently focused window determines the current user task. The FWF algorithm filters all file operations such that only events whose process identifier (PID) or some parent PID match that of the currently focused window are considered. The PID is a number or identification used by the operating system to uniquely identify the process.

The reduction of noise enables embodiments to expand the duration and scope of the relation window while eliminating or reducing unrelated file operations. FWF also expands the RW to a size that more meaningfully reflects the user task; rather than use a fixed size relation window that relates all events within that time interval. FWF starts a relation window when an application window gains focus, and ends it when the application window loses focus. This allows the relation window to more meaningfully coincide with the user task and have a broader scope of files to relate together.

Focused Task Filtering (FTF) broadens the definition of user task to the set of recently focused windows among which the user has switched focus as part of his work over a longer time interval (example, 5 or 10 minutes). The FTF thus considers relationships between files that are accessed while different windows are focused. FTF applies similar techniques as FWF, but also maintains a log of relation windows that occur over the last n seconds. For each file event within each new relation window, FTF increments the links to each of the files in previous relation windows in addition to the inner relation window increments of FWF, substantially broadening the time period which file relationships can be built while maintaining the advantages of filtering. For instance, some applications read a document completely to memory and minimally or never access the document again even though the user refers to that file through the application window (example, a window displaying a PDF (portable document format) to which a user refers during work), minimizing the ability to reason about use of that document in concert with other files.

One embodiment uses a Weight Carrying (WC) algorithm that is a variant of FTF. The WC maintains a record of the last set of file events that occurred while that widget had focus (a widget is an interface element with which a computer user interacts, such as window or text box). If that widget is focused again without witnessing a new file event matching the widget's PID, WC retrieves the last set of file events that occurred while that widget had focus, and inserts copies of those events into the file stream. This process has the effect of creating “fake” file events that provide embodiments with more information about how a file is used in concert with other files as part of the focused task.

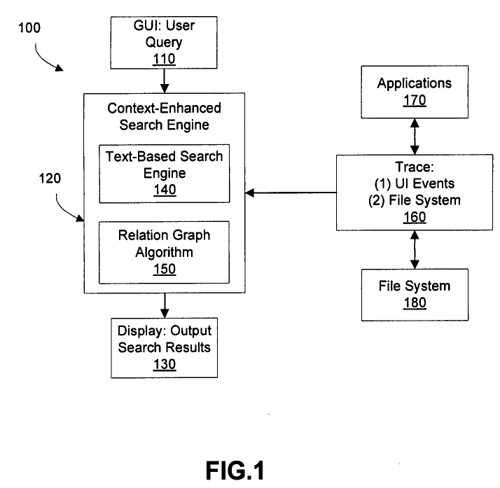

FIG. 1 illustrates a high-level block diagram of a computer system 100 for implementing an exemplary embodiment. A user enters a search or query (example, one or more keywords) through an interface 110, such as a graphical user interface. A context-enhanced search engine 120 receives the search and generates a ranked list of results at a display 130.

The context-enhanced search engine generally includes a text-based search engine 140 and a relation graph algorithm 150. When the search is received, the text based search engine 140 performs a content search for files having the keywords. Discovered files from this search are fed into the relation graph algorithm 150 which supplements the search results with contextual relationships. The combined search results from both the text-based search engine 140 and relation graph algorithm 150 are provided to the user.

In order to generate the contextual relationships, a trace 160 is located between applications 170 and file system 180. The trace 160 monitors UI events and the file system to identify contextual relationships between files running on one or more different applications. By way of example, files are mapped to nodes in a graph. Edges extend from one node to another and represent contextual relationships between files. The weight of an edge indicates the strength of a relation between two nodes or two files.

Information from trace 160 is output to the context-enhanced search engine 120. Here, the relation graph algorithm 150 identifies contextual relations in the information and generates appropriate relation graphs. By way of example, for each file discovered in the content search, the algorithm traverses from that file or node. Files connected to the node during this traversal are added to the search by constructing a sub-graph. Since files accessed within a given window of time are connected in the relation-graph, these files are discovered as being connected to the files in the content search. As discussed in more detail below, the relation window stores the input files accessed during a given time period (example, n-seconds). When a window encounters an output file, an edge is created in the relation-graph with a weight from the input file to the output file. This edge is discovered in the context-search after the content search.

By way of example, in one embodiment, the trace software includes two parts: a kernel layer hook and a UI layer hook. The kernel layer hook records read, write, rename, and delete file operations, along with data about the event, including file name, time, and process identifier. Additionally, process creation and deletion events are recorded, which enable generation of a relationship tree of processes. The process enables identification of parent/child relationships between process identifiers.

The UI layer hook monitors window focus (example, when a window gains focus via a mouse click, alt-tab, etc), widgets acquiring keyboard focus, window move/resize, and scroll events. Additionally, embodiments can record data about these events, such as time, process identifier, and window/widget identifiers. The event recording software maintains a log of events that are stored remotely or locally on a computer of the user.

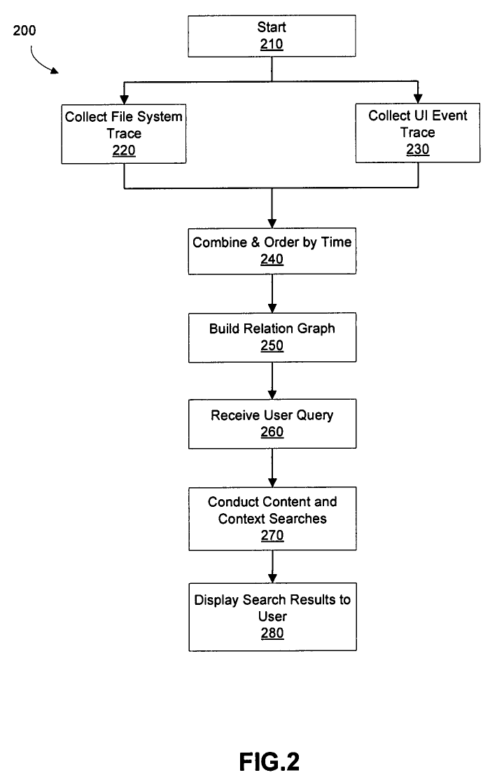

FIG. 2 is a flow diagram 200 for building a relation graph and conducting a search. The diagram starts at block 210 and simultaneously collects file system trace information at block 220 and UI event trace information at block 230. The file system trace information and UI event trace information are combined and ordered by time according to block 240. Information obtained from the traces is used to build the relation graphs according to block 250. According to block 260, a user enters a query, such as a keyword search into a personal computer. The search is conducted using both a content search engine and a context search (example, a relational graph) as shown in block 270. In one embodiment, the content search engine first performs a search based on keywords. The results of this search are provided to the context search engine. The results of the two searches are merged and are provided or displayed to the user according to block 280.

Embodiments leverage events from the UI layer to determine user tasks and, ultimately, contextual relations between different files simultaneously executing on one or more applications. When a window is focused, typically the cause is an action from the user, such as a mouse click in the window region or the alt-tab window switching command. The user communicates through the action that there is something on that window that is relevant for a current task. As events such as window or tab focuses are collected, the windows and tabs most related to the user's task are focused and used more heavily than others. Furthermore, events at the user interface provide insight into how relevant the file is to a user's task. For example, if document A consumes a large percentage of a display and is the focused document during a time interval, then an inference is made that this document is relevant during the time interval. If one document is paired with an editable text widget and has recently received numerous keyboard events, it can be reasoned that the file is “under development” or “heavily edited.” At the same time, another document that is viewed frequently but never changed is classified as being “frequently referred to.”

By way of illustration, some exemplary embodiments are described as users perform tasks using processes. A task is work for a specific goal, such as developing code, creating a text document, editing an image, etc. Tasks use processes and UI elements, including windows and widgets. Tasks are comprised of application processes that are in turn are comprised of windows through which users interact with the processes. Windows are composed of widgets, such as buttons and text areas.

Exemplary embodiments utilize one or more of various UI enhanced algorithms, namely focused window filtering (FWF), focused task filtering (FTF), weight carrying, window switching, and max-hash. These algorithms are discussed separately.

The Focused Window Filtering algorithm is an exemplary method to incorporate UI events into the context building algorithms. There are two exemplary contributions of this algorithm. First, information is maintained about the currently focused window whenever a file operation occurs. Further, the method ignores each file event whose process identifier (or some parent process identifier) does not match the process identifier of the currently focused window. The reasoning is that the currently focused window represents the active task for the user, and only file events generated by the task are considered. Parent PID matches are honored because many processes spawn sub-processes as part of their work. For example, a user working with a window command prompt might use javac at the command line to compile a source file; javac would be a sub-process of the command prompt and part of that task.

The second component to the FWF algorithm is a modification of the way in which relation windows are used. Rather than use a fixed size relation window that relates all events within that time interval, the method commences a relation window when an application window gains focus. The method ends a relation window when the application window loses focus. This allows the relation window to more meaningfully coincide with the user task and is more likely to relate file events that share task commonality.

For each new focused window, a new relation window is begun, and a record is made of the file name of each file that was read or written by a process whose PID or some parent PID matched the focused application window while that window was focused. At the end of a relation window, the method updates the relational graph by incrementing the link value between each file read during that interval, then again for each file written during that interval (see algorithm below).

```
reads ← getFilesRead(RW_{current});
writes← getF ilesWritten(RW_{current});
foreach read file rᵢ ∈ reads do
    foreach read file rⱼ ∈ reads ; rᵢ ≠ rⱼ do
        incrementGraph(rᵢ, rⱼ,(1/|reads|));
    end
end
foreach written file wᵢ ∈ writes do
    foreach written file wⱼ ∈ writes ; wᵢ ≠ wⱼ do
        incrementGraph(wᵢ, wⱼ, 1/|writes | );
    end
end
```

The method increments by one the strength of the relationship between every unique pair of files read or written during the relation window. These increments enhance the strength of the relationships between files during windows where few events occur. This is based on the observation that relation windows in which many file events occurred are often the result of large, non-interactive operations (such as the compilation of large projects or software version control system updates, which generate many read or write operations), and relation windows with fewer events tend to more accurately reflect direct user action. One embodiment separates relation building between reads and writes because reads and writes often correspond to different types of activity and should be related separately. For example, a user compiling a set of source files will generate two large sets of file activity; first, the reading of all source files, then, the writing of all compiled, object files.

The FWF provides a substantial reduction in the volume of background file events falsely related. At the same time though, the FWF does not relate file events that occur across the focuses of different application windows, even if those windows are part of the same conceptual user task. Further, the FWF does not relate file events occurring while the same application window is focused at different times. These instances are addressed with the FTF algorithm.

Focused Task Filtering extends the FWF algorithm by filtering file events by the focused user task rather than the focused window. One embodiment defines user task as the set of recently focused windows among which the user has switched focus as part of their work. FTF applies similar techniques as FWF, with a few additions.

First, FTF maintains a log of each relation window (corresponding to the period in which an application window was focused) that occurred during the last n seconds. For each new relation window RW current, one embodiment updates the graph according to the methods outlined in FWF. Additionally, for each relation window RWi in the log, one embodiment creates a set of file events that is the union of file events occurring in RWi and in RW current, and updates the graph with each of those sets. This connects the files of a given relation window to the files in each relation window that occurred within n seconds of it, regardless of which window/application generated those events, while still removing the impact of events generated from background processes.

The algorithm below depicts the pseudo-code of this operation. The algorithm accounts for the number of events occurring within a relation window, such that links formed to files within windows where a large number of file events occur are weaker than those in which few occur. For relation windows RW_{A} and RW_{B}, the algorithm updates the links from all files in RW_{A} to the files in RW_{B} by (1/|RWB|), and vice-versa.

```
RW_{current}: most recent relation window
log  : log of all relation windows in last n seconds (not
    including RW_{current} )
reads_{current} ← getFilesRead(RW_{current});
writes_{current} ← getFilesWritten(RW_{current});
foreach relation window RWᵢ∈ log do
    readsᵢ ← getFilesRead(RWᵢ);
    writesᵢ ← getFilesWritten(RWᵢ);
    foreach rᵢ ∈ readsᵢ do
        foreach rⱼ ∈ reads_{current} do
            incrementGraph(rᵢ, rⱼ, 1/|reads_{current} | );
            incrementGraph(rⱼ, rᵢ, 1/|readsᵢ | );
        end
    end
end
{Repeat for writes};
log← log ⊕ RW_{current}
```

One embodiment addresses the situation when a user is conceptually interacting with a file via an application (example, a PDF reading application) without that application generating new file events. This situation occurs when applications read a file completely to memory and no longer poll the file for updates.

The weight carrying (WC) algorithm addresses this situation. For each application widget, a record is maintained of the last set of file events that occurred while that widget had focus. If that widget is focused again without witnessing a new file event matching the PID of the widget's window's PID, the WC algorithm retrieves the last set of file events that occurred while that widget had focus, adds a copy of that window, and updates the graph as per the FTF. This creates fake file events that provide more information about how a file is used in concert with other files as part of the focused task

Discussion is now directed to a window stitching algorithm shown below.

```
RW_{current} : most recent relation window
AW_{current} : application window corresponding to RW_{current}
log  : log of all relation windows in last n seconds (not
    including RW_{current} )
reads_{current}← getFilesRead(RW_{current});
writes_{current} ← getFilesWritten(RW_{current}) ;
foreach relation window RWᵢ∈ log do
    readsᵢ ← getFilesRead(RWᵢ);
    writesᵢ ← getFilesWritten(RWᵢ);
    foreach rᵢ ∈ readsᵢ do
        foreach rⱼ ∈ reads_{current} do
            AWᵢ ← application window corresponding to RWᵢ ;
            inWeight← WSW from AW_{current} to AWᵢ ;
            outW eight← WSW from AWᵢ to AW_{current} ;
            incrementGraph(rᵢ, rⱼ, 1+inW eight/|reads_{current} | );
            incrementGraph(rⱼ, rᵢ, 1+outW eight/|readsᵢ | );
        end
    end
end
{Repeat for writes};
log← log ⊕ RW_{current}
```

At any given time, a user can have a large set of windows opened or minimized on the display. At the same time, a specific task with which that user interacts might only be composed of a small subset of the global window set. One expectation is to see the set of windows that are frequently focused change as the user moves between tasks. Under this model of user activity, an understanding of how tasks are organized across the set of UI components is realized by studying the way in which UI components are used together.

One embodiment implements this model into the algorithm by applying a weighting scheme to the task filtering algorithm which effects how file relationships are incremented in the relation graph. For every window Wᵢ, the algorithm maintains a likelihood of each window Wⱼ appearing in a focus interval of Wᵢ. A focus interval for window Wᵢ is the set of windows that appear between consecutive appearances of Wᵢ. Intuitively, windows that are more related to Wᵢ are more likely to appear between consecutive appearances of Wᵢ. The likelihood of Wⱼ appearing in Wᵢ's focus interval, or window switch weight (WSW), is a value between 0 and 1.

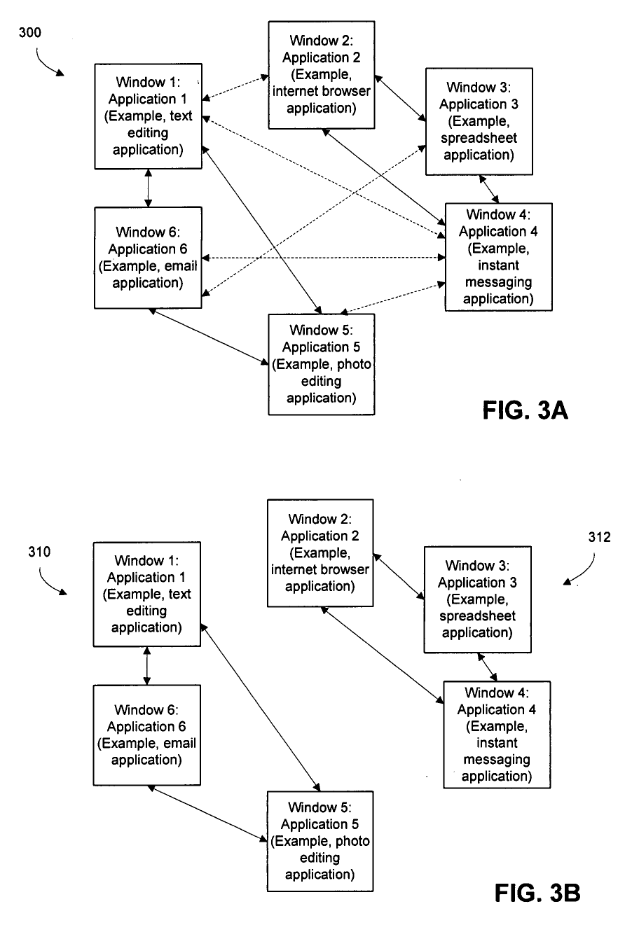

These concepts are illustrated in FIGS. 3A and 3B. FIG. 3A shows a group of windows and applications 300 simultaneously open on a display of a computer. The lines extending between the different applications and windows indicate some likelihood of the other occurring within a focus interval. Here, a weaker likelihood is represented with dashed lines, while a stronger likelihood is represented with solid lines. As shown in FIG. 3B, when the dashed lines are removed, clusters 310 and 312 of more tightly connected windows are revealed. The cluster of windows has accesses that are temporally similar. This temporal similarity can indicate task commonality.

Next, the concept of coverage weighting is discussed. Processes typically employ a set of configuration and state-maintenance files throughout their execution, transparently to the user. Consequently, the file event tracing any user activity that involves this process will be interleaved by file events corresponding to these files. As such, two tasks that use a common application will include these files in their file set. This makes them appear similar even if each of the remaining files are distinct. Similarly, applications that are consistently used across all tasks, such as a mail application, might introduce file events pertaining specifically to those applications. As a result, there is a prevalence of “globally useful” files. These files feature many incoming links from distinct tasks to which this file has a weak or non-existent conceptual relationship.

Manifested on the relational graph, sets of tightly connected sub-graphs exist that correspond to tasks. These subgraphs share links to files containing a disproportionate number of incoming links and tend to bridge the otherwise distinct subgraphs. To reduce the influence of these “super-node” files, one embodiment uses a coverage weighting value.

Coverage weighting is a metric that indicates the exclusivity of the relationship between a given file to a given task set. Assume a user initiates a search on file F_{A} on the relation graph G. The method includes each file Fᵢ to which a direct link exists from F_{A}, creating node set P_{A}⊂G. Recall that each link from F_{A} to Fᵢ contains some value that indicates the strength of the relationship of Fᵢ to F_{A}. Given this pool of files directly connected from F_{A}, the method finds a coverage weight CW(Fᵢ) for each file Fᵢ. Coverage weight is defined as:

$$CW ( {F}_{i} ) = {( \frac{{\sum }_{{F}_{j} ∈ {P}_{A} : {F}_{j} \neq {F}_{i}} linkValue ( {F}_{i} , {F}_{j} )}{{\sum }_{{F}_{j} ∈ G : {F}_{j} \neq {F}_{i}} linkValue ( {F}_{i} , {F}_{j} )} )}^{2}$$

In one embodiment, coverage weighting represents the amount of a total outgoing weight of a file that is part of a given file set. A high coverage weight indicates a file's relationship to a file set is close to exclusive. On the other hand, a weak weight indicates a file is related to many other file sets.

Coverage weight is applied in the UI-aware algorithms during searches. Upon initiating a search on file F_{A}, one embodiment creates a pool of directly connected files and then multiplies their link values by their coverage weight over this pool.

One embodiment uses max-hash, a method to approximate set commonality. For a given set, the method applies a hash function (such as MD5, message digest algorithm 5) to each item within the set, creates a new set of integer identifiers, and then sorts the identifiers to find the n maximum values. The likelihood that two sets share the same maximum hash value is equal to the proportion of the intersection of the sets to their union (S_{A}∩S_{B}/S_{A}∪S_{B}). Sets that share a large portion of their top n values are more likely to be very similar sets.

The max-hash algorithm is applied in one embodiment by viewing each file as a set of FTF appearances (i.e., the set of n-second intervals in which that file appears). One embodiment then applies a unique, random identifier to each of these intervals. For example, upon a search on file F_{A}, the method finds the n highest hash values for the items in F_{A}, then finds the set of files that share at least one of those hash values in their top n hash values. The list is then sorted by the number of hash values they share with F_{A} to produce the final pool of results.

In one embodiment, the max-has algorithm splits the events into discrete time intervals and assigns each interval a discrete value uniquely identifying the interval. Then, for each file in the event trace, the algorithm records the set of interval identifiers it is accessed within and hashes the identifiers associated with each file. Next, the algorithm selects the largest of the hashed identifiers and identifies the files with the largest number of shared hashed identifiers.

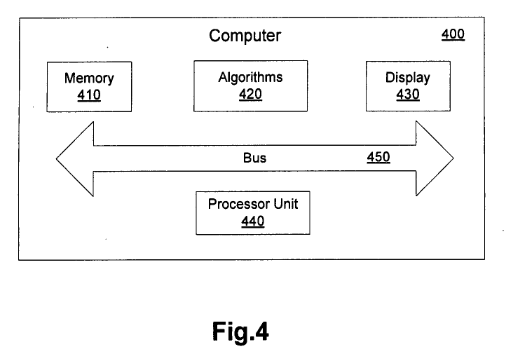

FIG. 4 is a block diagram of a server or computer 400 in accordance with an exemplary embodiment. In one embodiment, the computer includes memory 410, one or more algorithms 420 (example, algorithms for implementing one or more aspects of exemplary embodiments), display 430, processing unit 440 and one or more buses 450.

In one embodiment, the processor unit includes a processor (such as a central processing unit, CPU, microprocessor, etc.) for controlling the overall operation of memory 410 (such as random access memory (RAM) for temporary data storage, read only memory (ROM) for permanent data storage, and firmware). The memory 410, for example, stores applications, data, programs, algorithms (including software to implement or assist in implementing embodiments herein) and other data. The processing unit 440 communicates with memory 410 and display 430 via one or more buses 450.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments are provided as examples and should not be construed to limit other embodiments. For instance, blocks in diagrams or numbers (such as (1), (2), etc.) should not be construed as steps that must proceed in a particular order. Additional blocks/steps may be added, some blocks/steps removed, or the order of the blocks/steps altered and still be within exemplary embodiments. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the embodiments.

Various embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments. Numerous variations and modifications will become apparent to those skilled in the art once the above disclosure is fully appreciated. It is intended that the following claims be interpreted to embrace all such variations and modifications.

What is claimed is:

1) A method of software execution, comprising:
collecting user interface events;
using the user interface events to generate a group of files that are related to a task;
enhancing a query to discover files associated with the task.

2) The method of claim 1, wherein the user interface events include at least one of keyboard inputs, window focus changes, clicks from a mouse or pointer, window visibility events, widget focus changes, and mouse or pointer movement.

3) The method of claim 1 further comprising, archiving discovered files associated with the task in a same storage location.

4) The method of claim 1 further comprising, locating files previously accessed and opened during a specified time period.

5) The method of claim 1 further comprising, generating a list of files that are derived from a discovered file associated with the task.

6) A method, comprising:
storing information about file operations that occur in an application having a window focused on a computer;
ignoring information about file operations by applications executing on the computer but not having a focused window;
using the information about file operations to enhance a search query for a file.

7) The method of claim 6 further comprising:
ignoring the file operations of applications having process identifiers that do not match a process identifier of the application having the window focused on the computer;
displaying results to the search query.

8) The method of claim 6 further comprising, distinguishing between file operations generated by an application while a user performs a task and file operations generated from a background process not associated with the task.

9) The method of claim 6 further comprising, determining if read operations generated by another application executing in a background of the computer relate to a task of a user.

10) The method of claim 6 further comprising, identifying an application that after an initialization period does not generate file operations when a user performs tasks in the identified application.

11) The method of claim 6 further comprising, tracking consecutive window focuses between plural different windows to determine a subset of related windows in the plural different windows.

12) A computer-readable medium having computer-readable program code embodied therein for causing a computer system to perform:
building a relation graph by distinguishing between file events generated from a first application having a focused window and file events generated from a second application without a focused window;
using the relation graph to discover a group of files;
displaying the group of files.

13) The computer-readable medium of claim 12 for causing the computer system to further perform: tracking consecutive window focuses between plural different windows to determine a subset of related windows in the plural different windows.

14) The computer-readable medium of claim 12 for causing the computer system to further perform: tracking a size of a window in a third application to determine if a file running the third application is related to the group of files.

15) The computer-readable medium of claim 12 for causing the computer system to further perform:
splitting the file events into discrete time intervals;
assigning each time interval a discrete value uniquely identifying the time interval;
for each file in an event trace, recording a set of interval identifiers;
hashing the set of interval identifiers associated with each file;
identifying files with a largest number of shared hashed identifiers.

16) The computer-readable medium of claim 12 for causing the computer system to further perform: commencing a relation window (RW) when an application window gains focus, and ending the RW when the application window loses focus.

17) The computer-readable medium of claim 12 for causing the computer system to further perform: recoding a file name of each file read by and written by a process whose process identifier (PID) matches a PID of the first application.

18) The computer-readable medium of claim 12 for causing the computer system to further perform:
maintaining a record of file events that occurred while a widget is focused;
determining if the widget is focused again without generating a new file event matching a process identifier of a window of the widget.

19) The computer-readable medium of claim 12 for causing the computer system to further perform: creating false file events for an application that reads a file into memory and then no longer polls the file for file event updates.

20) A computer system, comprising:
a display;
a memory that stores an algorithm;
a processor that executes the algorithm to:
construct a searching tool that distinguishes between file events generated while an application has a window focused on the display and file events generated from an application without a window focused on the display.

21) The computer system of claim 20, wherein the processor further executes the algorithm to determine if two files simultaneously executing on two different applications are related by tracking when windows for the two files are focused with respect to each other.

22) The computer system of claim 20, wherein the processor further executes the algorithm to remove file events that are generated by applications executing in a background of the computer system.

23) The computer system of claim 20, wherein the processor further executes the algorithm to filter file events that are generated by applications unrelated to a task performed by a user.

24) The computer system of claim 20, wherein the processor further executes the algorithm to determine if file events that are generated by applications are noise.

25) The computer system of claim 20, wherein the processor further executes the algorithm to ignore file events generated from the application without a window focused on the display.
